(19) United States
(12) Patent Application Publication
(10) Pub. No.: US 2002/0152340 A1
(43) Pub. Date: Oct. 17, 2002

(54) Pseudo-differential parallel source synchronous bus

(75) Inventors: Daniel Mark Dreps, Georgetown, TX (US); Robert Russell Williams, Rochester, MN (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/821,065

(22) Filed: Mar. 29, 2001

(51) Int. Cl. G06F 13/00

(52) U.S. Cl. 710/100

(57) ABSTRACT

The present invention provides a bus for use in a data processing system. In one embodiment, the bus includes a clock driver, a clock receiver, a plurality of drivers, and a plurality of receivers. The clock receiver is coupled to the clock driver by two clock bus lines carrying complementary clock pulses. Each of the plurality of receivers each coupled to a respective one of the plurality of drivers by bus lines, wherein the receivers detect signals on respective bus lines with respect to a reference voltage derived from a combination of the complementary clock pulses.

### BACKGROUND OF THE INVENTION

1. Technical Field:

The present invention relates generally to an improved data processing system and, more particularly, to an improved synchronous bus for use in a data processing system.

2. Description of Related Art:

Buses are used in computers to carry data between various components such as memory devices and the processor. One type of bus used is a synchronous source bus. A synchronous source bus is a parallel bus carrying several bits of information on different lines of the bus. The data on each bus line is synchronized to the data on the other bus lines. Synchronous refers to events that are synchronized, or coordinated, in time. Multiple electronic events on different lines occur coordinated in time with reference to a source pulsed clock. For example, the interval between transmitting A and B is the same as between B and C, and completing the current operation before the next one is started are considered synchronous operations. Contrast with asynchronous mode in which events are started at a speed determined by circuit functions rather than by timing signals.

In synchronous buses, codes (clock signals) are sent from the transmitting station to the receiving station to establish synchronization, and data is then transmitted in continuous streams. One problem with synchronous source buses as currently implemented is that they may not be used at higher frequencies because of skew (a change of timing or phases in a transmission signal) that result from voltage decreases and increases in line loss resulting from increased bit rates. However, computers are being run at increasingly faster speeds. Therefore, it would be desirable to have a synchronous bus that is capable of operation at higher frequencies than currently available synchronous buses.

### SUMMARY OF THE INVENTION

The present invention provides a bus for use in a data processing system. In one embodiment, the bus includes a clock driver, a clock receiver, a plurality of drivers, and a plurality of receivers. The clock receiver is coupled to the clock driver by two clock bus lines carrying complementary clock pulses. Each of the plurality of receivers each coupled to a respective one of the plurality of drivers by bus lines, wherein the receivers detect signals on respective bus lines with respect to a reference voltage derived from a combination of the complementary clock pulses.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram illustrating a data processing system in which the present invention may be implemented;

FIG. 2 depicts a block diagram of a prior art bus topology;

FIG. 3 depicts an improved source synchronous bus capable of driving data at higher frequencies than current source synchronous buses in accordance with the present invention;

FIG. 4 depicts a block diagram illustrating an example of a clock receiver and reference voltage generator in accordance with the present invention; and

FIG. 5 depicts a block diagram illustrating a second embodiment of a clock receiver and reference voltage generator in accordance with the present invention.

### DETAILED DESCRIPTION OF THE PREFERRED EMBODIMENT

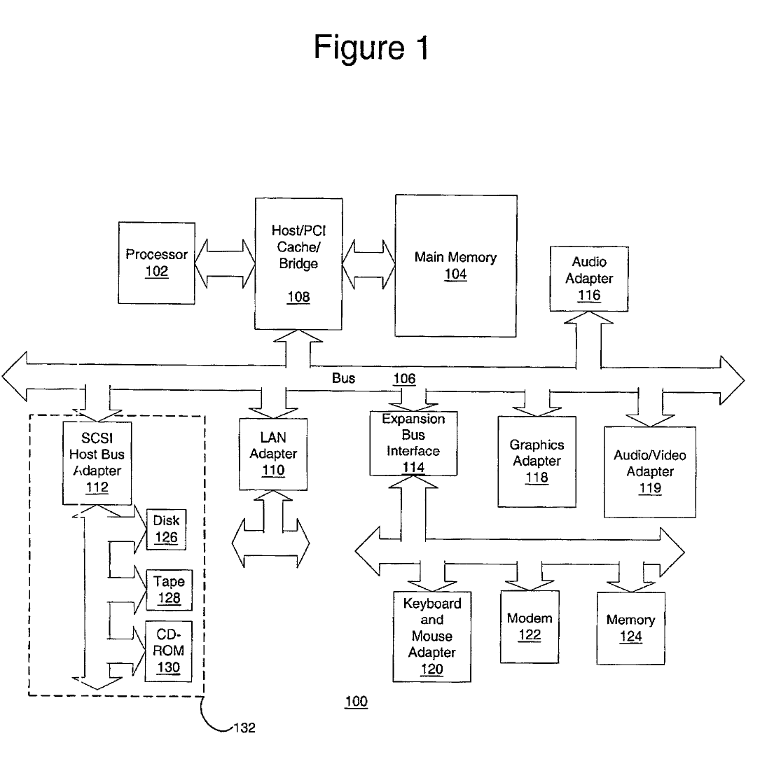

With reference now to FIG. 1, a block diagram illustrating a data processing system is depicted in which the present invention may be implemented. Data processing system 100 is an example of a client computer. Data processing system 100 employs a peripheral component interconnect (PCI) local bus architecture. Although the depicted example employs a PCI bus, other bus architectures such as Accelerated Graphics Port (AGP) and Industry Standard Architecture (ISA) may be used. Processor 102 and main memory 104 are connected to PCI local bus 106 through PCI bridge 108. PCI bridge 108 also may include an integrated memory controller and cache memory for processor 102. Additional connections to PCI local bus 106 may be made through direct component interconnection or through add-in boards. In the depicted example, local area network (LAN) adapter 110, SCSI host bus adapter 112, and expansion bus interface 114 are connected to PCI local bus 106 by direct component connection. In contrast, audio adapter 116, graphics adapter 118, and audio/video adapter 119 are connected to PCI local bus 106 by add-in boards inserted into expansion slots. Expansion bus interface 114 provides a connection for a keyboard and mouse adapter 120, modem 122, and additional memory 124. Small computer system interface (SCSI) host bus adapter 112 provides a connection for hard disk drive 126, tape drive 128, and CD-ROM drive 130. Typical PCI local bus implementations will support three or four PCI expansion slots or add-in connectors.

An operating system runs on processor 102 and is used to coordinate and provide control of various components within data processing system 100 in FIG. 1. The operating system may be a commercially available operating system, such as Windows 2000, which is available from Microsoft Corporation. An object oriented programming system such as Java may run in conjunction with the operating system and provide calls to the operating system from Java programs or applications executing on data processing system 100. “Java” is a trademark of Sun Microsystems, Inc. Instructions for the operating system, the object-oriented operating system, and applications or programs are located on storage disk 126, and may be loaded into main memory 104 for execution by processor 102.

Those of ordinary skill in the art will appreciate that the hardware in FIG. 1 may vary depending on the implementation. Other internal hardware or peripheral devices, such as flash ROM (or equivalent nonvolatile memory) or optical disk drives and the like, may be used in addition to or in place of the hardware depicted in FIG. 1. Also, the processes of the present invention may be applied to a multiprocessor data processing system.

As another example, data processing system 100 may be a stand-alone system configured to be bootable without relying on some type of network communication interface, whether or not data processing system 100 comprises some type of network communication interface. As a further example, data processing system 100 may be a Personal Digital Assistant (PDA) device, which is configured with ROM and/or flash ROM in order to provide non-volatile memory for storing operating system files and/or user-generated data.

The depicted example in FIG. 1 and above-described examples are not meant to imply architectural limitations. For example, data processing system 100 also may be a notebook computer or hand held computer in addition to taking the form of a PDA. Data processing system 100 also may be a kiosk or a Web appliance.

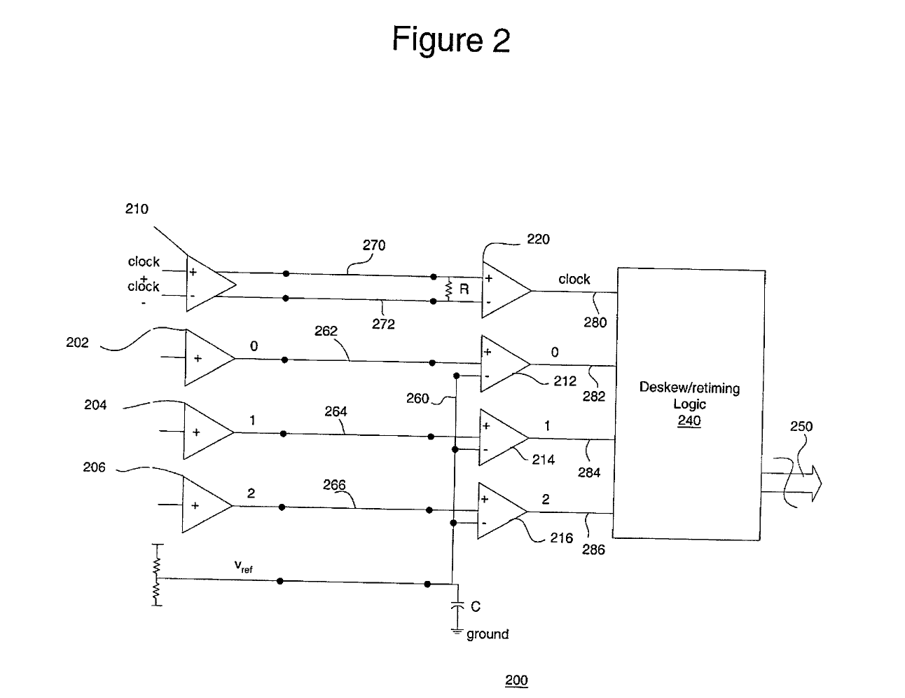

With reference now to FIG. 2, a block diagram of a prior art bus topology is depicted. Bus 200 is a low swing single ended data bit bus and may be implemented as a bus within one of the components of data processing system 100 in FIG. 1, such as, for example, processor 102. Examples of low swing single ended data buses with reference voltage data receivers include rambus and Gunning Transceiver Logic (GTL) buses. Bus 200 includes three data drivers 202, 204, 206 and a clock driver 210 that includes both a positive and negative clock pulse. Bus 200 also includes three bus receivers 212, 214, 216 and a clock receiver 220 connected to bus drivers 202, 204, 206 and clock driver 210 by bus lines 262, 264, 266 and 270 and 272 respectively. The outputs 280, 282, 284, 286 of clock receiver 220 and bus receivers 212, 214, 216 is coupled to deskew/retiming logic 240 which has an output 250 to couple to other components of a data processing system. Clock bus lines 270 and 272 carrying the positive and negative clock pulses respectively are joined through by a resistor R.

An analog voltage V_{ref} is sent from the drive side of the bus 200 to each of the data receivers 212, 214, 216. The noise must be managed such that the direct current (DC) midfrequency (less than around 50 MHz) noise generated from the drive side is transmitted to the receiver. By doing this, the noise tends to track the driver data bits. This results in a noise asymmetry or shift with respect to the reference voltage V_{ref} when the data bits shift up and down. The high frequency noise is then filtered out by amplifiers 212, 214, 216 based upon the stable reference voltage V_{ref}. However, this design requires that source synchronous buses such as bus 200 must operate as differential busses at higher frequencies such as, for example, at frequencies higher than around 500 megabits per second. This is because single ended data bit buses require large amplitude signal swings to provide adequate noise margin.

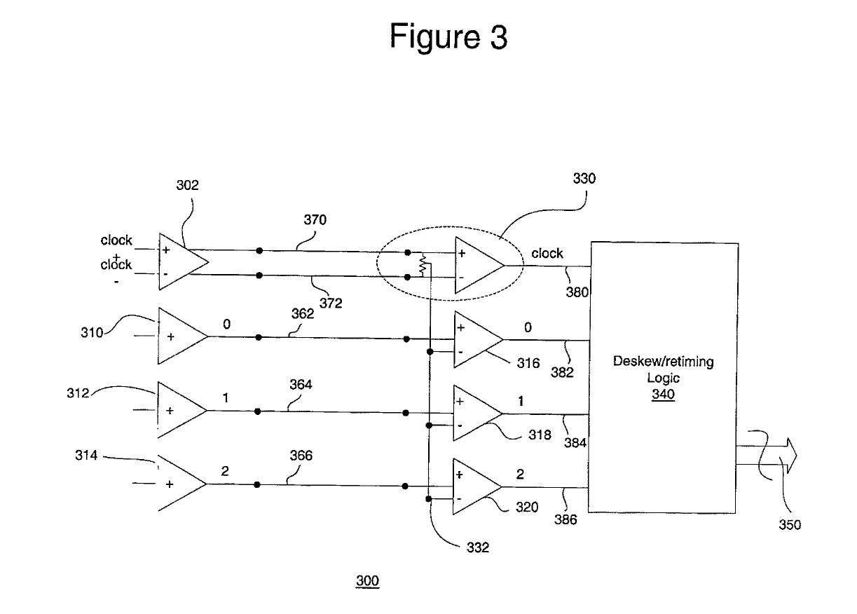

With reference now to FIG. 3, an improved source synchronous bus capable of driving data at higher frequencies than current source synchronous buses is depicted in accordance with the present invention. Bus 300 is an example of a synchronous source bus or low-swing single ended data bus with reference voltage data receivers that may be implemented within one or more components of data processing system 100 in FIG. 1, such as, for example, processor 102. Bus 300 is terminated by any of a number of source termination techniques which are well known in the art. Bus 300 includes three data drivers 310, 312, 314 and three data receivers 316, 318, 320 coupled by three bus lines 362, 364, 366 similar to bus 200 in FIG. 2. Bus 300 also includes a clock pulse driver 302 driving both negative and positive clock pulses on clock bus lines 370 and 372 to clock receiver and reference voltage generator 330. The outputs 380, 382, 384, 386 from clock receiver and reference voltage generator 330 and data receivers 316, 318, 320 are coupled to deskew/retiming logic 340 with an output 350 to other components as with bus 200. Deskew/retiming logic 340 may be, for example, a rambus interface, elastic interface, STI interface, or RIO interface.

However, although bus 300 is similar in many ways to bus 200, bus 300 does not include a separate reference voltage pin, but rather draws the reference voltage signal 332 needed by data receivers 316, 318, 320 from the complementary clock pulses on clock bus lines 370 and 372. This design enables data to be driven at higher frequencies than bus 200. This is so in part because the reference voltage on bus 300 better correlates with the noise. Also, as noted above, since no additional vref pins are required, bus 300 can be integrated within circuits which use a “vanilla” source synchronous design without requiring a supplemental line. The clock receiver and reference voltage generator 330 may be implemented in several ways. Two possible embodiments are described below.

Although bus 300 has been described as a three line data bus, it will be obvious to one skilled in the art that the design may be expanded to a bus having as many data lines as necessary for the required application.

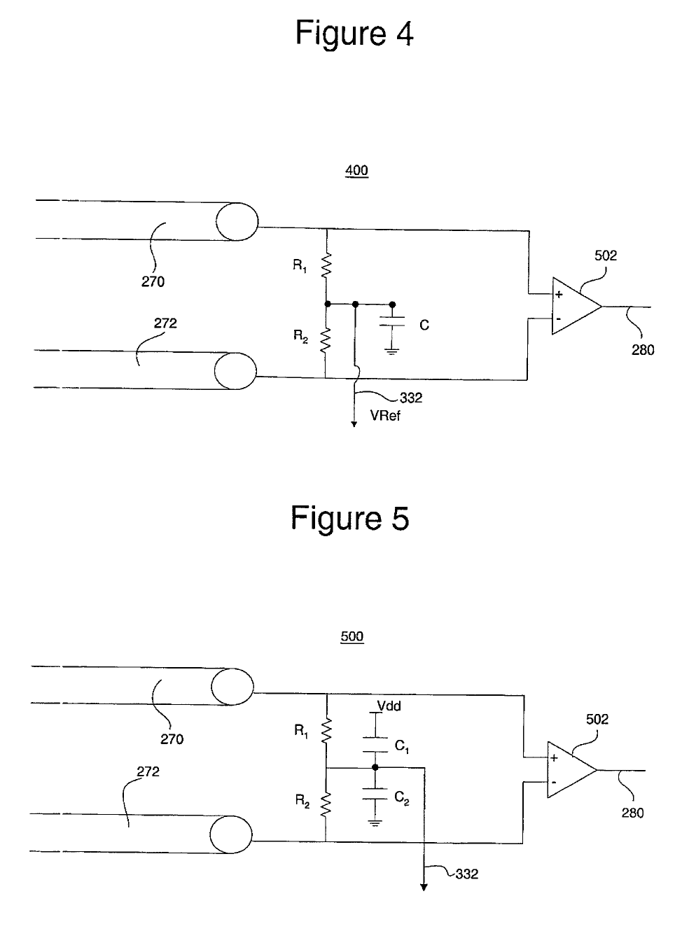

With reference now to FIG. 4, a block diagram illustrating an example of a clock receiver and reference voltage generator is depicted in accordance with the present invention. Receiver 400 may be implemented as, for example, clock receiver and reference voltage generator 330 in FIG. 3. Receiver 400 is an example of a receiver suitable for use inside low-power memory controller type devices. Receiver 400 includes clock differential amplifier receiver 502 with inputs coupled to clock bus lines 270 and 272 and an output 280 for coupling clock receiver 502 to deskew/retiming logic, such as, for example, deskew/retiming logic 340 in FIG. 3. Clock bus lines 270 and 272 carry positive and negative clock signals respectively and are coupled to each other by resistors R₁ and R₂ arranged in series. Resistors R₁ and R₂ are preferably approximately 50 ohm resistors. A reference voltage signal 332 is taken from the node connection between resistors R₁ and R₂, which node also includes filter capacitor C to ground. Reference voltage signal 332 is also provided as the input to the multiple bus lines as the reference voltage for data receivers for a source synchronous bus such as bus 300. Capacitor C is preferably an approximately 200 pico-farad capacitor. Capacitor C filters out switching noise of the differential receiver circuits.

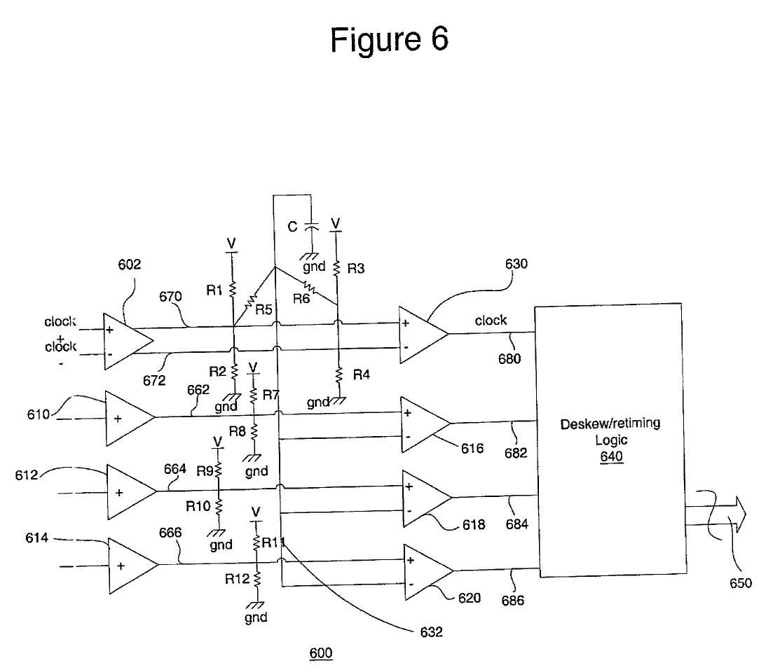

With reference now to FIG. 5, a block diagram illustrating a second embodiment of a clock receiver and reference voltage generator is depicted in accordance with the present invention. Receiver 500 may be implemented as, for example, clock receiver and reference voltage generator 330 in FIG. 3. Receiver 500 is an example of a receiver suitable for use inside high-power processors where the noise tends to be symmetric (i.e. the switching of circuits internal to the chip tend to pull Vdd down at the same time and in comparable degrees that ground is pulled upward).

Receiver 500 includes clock differential amplifier receiver 502 with inputs coupled to clock bus lines 270 and 272 and an output 280 for coupling clock receiver 502 to deskew/retiming logic, such as, for example, deskew/retiming logic 340 in FIG. 3.

Clock bus lines 270 and 272 carry positive and negative clock signals respectively and are coupled to each other by resistors R₁ and R₂ arranged in series. Resistors R₁ and R₂ are preferably approximately 50 ohm resistors just as in the previous embodiment. A reference voltage signal 332 is taken from the node connection between resistors R₁ and R₂ as in the previous embodiment. However, rather than connecting the node of the reference voltage signal 332 through a single capacitor coupled to ground as in the previous embodiment, reference voltage 332 has complementary connected capacitors C₁ and C₂ sharing the node. Capacitor C₁ is connected at its opposite end to a voltage V_{dd} while capacitor C₂ is connected to ground. Each capacitor C₁ and C₂ is preferably approximately 100-200 pico-farads in value. Capacitors C₁ and C₂ filter out the switching noise from the differential receiver circuits. This noise can affect the Vref voltage if not filtered. For example, if a large number of bus line receivers were receiving a rising signal, Vref could change in the absence of such filter, a fact which would adversely affect an additional receiver experiencing a falling signal on the bus line. Furthermore, such change in the Vref would affect the delays through the 30 receivers was well. Delays will change because the receiver circuits switch when a signal being received falls past a Vref or rises past a Vref voltage. Typical voltage slew rates (dv/dt) of incoming signals range from 0.5 volts/nanosecond to 4 volts/nanosecond. Thus, if the Vref has been moved 0.2 volts due to coupling noise described above, the delay through the receiver will be changed by, for example, (0.2 volts)/(0.5 volts/nanosecond), or 0.4 nanoseconds. This variation is intolerable at the data rates required in todays high speed buses.

One difference between receiver 400 and receiver 500 is that receiver 500 is preferred when on-chip V_{dd}-Ground voltage collapses in a symmetric manner during on-chip switching activity. For example, if V_{dd} drops 0.1 volt at the same time the ground rises 0.1 volt, both measured with respect to steady state values. If such is the case, which is common, and the two capacitors C₁ and C₂ are of equal value, the Vref 332 will not change relative to the absolute values. In contrast, if receiver 400 is used in such case (i.e. V_{dd} drops 0.1 volt and ground rises 0.1 volt), Vref 332 will rise 0.1 volt relative to the absolute ground.

Bus 300 utilizes a clock that is of a push-pull type so that the common-mode voltage would be exactly the Vswing/2 if all were perfect. Hence, the data bits swing symmetrically around a V_{dd}/2 level. Resistors R₁ and R₂ are preferably impedance matched to the transmission lines 270 and 272. Thus, for example, if the transmission line 270 and 272 impedance is 50 ohms, then, preferably, the clock receiver is terminated into a pair of 50 ohm resistors, the common node point being the connection between the two resistors.

The present embodiments require no special off-chip decoupling. The mismatches at the clock/data driver are fed forward to generate a compensating offset at the receiver. The clock pulse drive 302 and data drivers 310, 312, 314 are preferably of matching type for best noise cancellation and tracking from the transmit side for better common mode rejection. The data/clock receivers 502, 316, 318, 320 preferably also match. Under these circumstances, the common mode rejection provides a single ended bus where the Vref at the receivers shifts in a direction which maximizes the noise margin. Furthermore, the present invention can be used with devices lacking an external Vref line. The present invention is also compatible with terminated, dynamic clamp, equalizing receivers and may be used at the input to drivers re-timing/deskew circuits.

With reference now to FIG. 6, an alternative embodiment of an improved source synchronous bus capable of driving data at higher frequencies than current source synchronous buses is depicted in accordance with the present invention. Bus 600 is an example of a split terminated design. Bus 600 is similar to bus 300 in FIG. 3. Bus 600 includes three data drivers 610, 612, 614 and three data receivers 616, 618, 620 coupled by three bus lines 662, 664, 666. Bus 600 also includes a clock pulse driver 602 driving both negative and positive clock pulses along clock bus lines 670 and 672 to clock receiver 630. The outputs 680, 682, 684, 686 from clock receiver 630 and data receivers 616, 618, 620 are coupled to deskew/retiming logic 640 with an output 650 to other components. As discussed above, deskew/retiming logic 640 may be, for example, a rambus interface, elastic interface, STI interface, or RIO interface.

Each data bus line 662, 664, 666 and clock bus lines 670 and 672 is split terminated such that each of bus lines 662, 664, 666, 670 and 672 are coupled to supply voltage Vdd through a respective divider resistor pairs R7/R8, R9/R10, R11/R12, R1/R2, and R3/R4 . Preferably, resistors R1-R4 and R7-R12 have identical or substantially similar impedance values that match to the impedance of their respective bus lines 670, 672, 662, 664, and 666.

The reference voltage line 632 for each of receivers 616, 618, 620 is connected to clock bus lines 670 and 672 through balanced resistors R5 and R6, and is connected to ground through filter capacitor C. Resistor R5 connects reference voltage line 632 to clock bus line 670 and resistor R6 connects reference voltage line 632 to clock bus line 672, thus the reference voltage is the difference between the positive and negative clock pulses. Capacitor C filters out the switching noise.

Although bus 600 has been described as a three line data bus, it will be obvious to one skilled in the art that the design may be expanded to a bus having as many data lines as necessary for the required application. Therefore, the present invention is not limited to buses having only three bus lines.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A bus design, comprising:
a clock driver;
a clock receiver coupled to the clock driver by two clock bus lines carrying complementary clock pulses;
a plurality of drivers;
a plurality of receivers each coupled to a respective one of the plurality of drivers by bus lines, said receivers detecting signals on respective bus lines with respect to a reference voltage derived from a combination of the complementary clock pulses.

2. The bus as recited in claim 1, wherein said reference voltage is derived from a resistive connection between said complementary clock pulses.

3. The bus as recited in claim 2, wherein the resistors in the resistive connection have an approximately equivalent resistance.

4. The bus as recited in claim 3, wherein the resistance is approximately equivalent to the resistance of the bus lines.

5. The bus as recited in claim 2, further comprising:
a first filter capacitor connecting said reference voltage signal to ground.

6. The bus as recited in claim 5, further comprising:
a second filter capacitor connecting said reference voltage to a supply voltage source.

7. The bus as recited in claim 6, wherein the first and second filter capacitors have an approximately equivalent capacitance.

8. The bus as recited in claim 7, wherein the capacitance is within a range of approximately 100 pico-farads and approximately 200 pico-farads.

9. The bus as recited in claim 1, further comprising:
a plurality of outputs from the data receivers coupled to a deskew/retiming logic component.

10. A data processing system, comprising:
a plurality of components; and
a bus coupling at least two of the plurality of components; wherein the bus comprises:
a clock driver;
a clock receiver coupled to the clock driver by two clock bus lines carrying complementary clock pulses;
a plurality of drivers;
a plurality of receivers each coupled to a respective one of the plurality of drivers by bus lines, said receivers detecting signals on respective bus lines with respect to a reference voltage derived from a combination of the complementary clock pulses.

11. The data processing system as recited in claim 10, wherein said reference voltage is derived from a resistive connection between said complementary clock pulses.

12. The data processing system as recited in claim 11, wherein the resistors in the resistive connection have an approximately equivalent resistance.

13. The data processing system as recited in claim 12, wherein the resistance is approximately fifty ohms.

14. The data processing system as recited in claim 11, further comprising:
a first filter capacitor connecting said reference voltage signal to ground.

15. The data processing system as recited in claim 14, further comprising:
a second filter capacitor connecting said reference voltage to a supply voltage source.

16. The data processing system as recited in claim 15, wherein the first and second filter capacitors have an approximately equivalent capacitance.

17. The data processing system as recited in claim 16, wherein the capacitance is within a range of approximately 100 pico-farads and approximately 200 pico-farads.

18. The data processing system as recited in claim 11, further comprising:
a plurality of outputs from the data receivers coupled to a deskew/retiming logic component.
